(19) United States
(12) Patent Application Publication
(10) Pub. No.: US 2026/0088326 A1
(43) Pub. Date: Mar. 26, 2026

(54) ALL-SOLID-STATE BATTERY FIXING DEVICE AND ALL-SOLID-STATE BATTERY TRANSFER SYSTEM INCLUDING THE SAME

(71) Applicant: MEERE COMPANY INC., Hwaseong-si (KR)

(72) Inventors: Jae Young AN, Hwaseong-si (KR); Yong Man JANG, Yongin-si (KR); Sang Man LEE, Suwon-si (KR)

(73) Assignee: MEERE COMPANY INC., Hwaseong-si (KR)

(21) Appl. No.: 19/337,776

(22) Filed: Sep. 23, 2025

(30) Foreign Application Priority Data
Sep. 25, 2024 (KR) 10-2024-0130041
Sep. 25, 2024 (KR) 10-2024-0130043
Aug. 22, 2025 (KR) 10-2025-0117198

(51) Int. Cl. H01M 10/04; H01M 10/052; H01M 10/0562; H01M 10/615

(52) U.S. Cl. CPC H01M 10/0404; H01M 10/045; H01M 10/0481; H01M 10/0486; H01M 10/052; H01M 10/0562; H01M 10/615; H01M 2300/0065

(57) ABSTRACT

Provided are an all-solid-state battery fixing device relates to an all-solid-state battery fixing device coupled to a transfer system for transferring an all-solid-state battery, and may include a first transfer plate configured to be coupled to a first conveyor device of the transfer system, a second transfer plate configured to be coupled to a second conveyor device of the transfer system positioned apart from the first conveyor device, and to face the first transfer plate with the all-solid-state battery therebetween, a first fixing part configured to fix the first transfer plate to the first conveyor device, and to pass through the first transfer plate, and a second fixing part configured to fix the second transfer plate to the second conveyor device, to pass through the second transfer plate, and to be positioned at a position corresponding to the first fixing part.

### CROSS-REFERENCE TO RELATED APPLICATION

This application claims the benefit of Korean Patent Applications No. 10-2024-0130041, filed on Sep. 25, 2024, No. 10-2024-0130043, filed on Sep. 25, 2024 and No. 10-2025-0117198, filed on Aug. 22, 2025 in the Korean Intellectual Property Office, the disclosure of which is incorporated herein in its entirety by reference.

### BACKGROUND

### 1. Field

Embodiments of the present disclosure relate to an all-solid-state battery fixing device and an all-solid-state battery transfer system including the same.

### 2. Description of the Related Art

Lithium-ion batteries have reached their limits in improving performance, and recently, an all-solid-state battery which replaces an electrolyte with a solid electrolyte has been attracting attention.

Compared to a secondary battery that generally uses a liquid electrolyte, an all-solid-state battery is free from electrolyte decomposition caused by overcharging of a battery, while also having high cycle durability and energy density. Additionally, since its electrolyte is solid, it is less susceptible to temperature fluctuations and external shocks, and it further provides a higher energy density than a lithium-ion battery.

In some embodiments, in an all-solid-state battery, it is known that a contact resistance between active material particles responsible for a battery reaction, or between an active material particle and a solid electrolyte particle, significantly affects an internal resistance of the battery, so that a technology is being proposed to improve a contact between active material particles, or between the active material particle and the solid electrolyte particle, thereby suppressing an increase in the internal resistance.

As a method for manufacturing an all-solid-state battery to improve the contact between these particles, a method for bringing the particles closer to each other so that gaps between the particles are minimized has been proposed, and methods for manufacturing an all-solid-state battery by compressing and manufacturing the all-solid-state battery have been proposed. The above described background art is technical information retained by the inventor to derive the present disclosure or acquired by the inventor while deriving the present disclosure, and thus should not be construed as publicly known art that was known prior to the filing date of the present disclosure.

### SUMMARY

Embodiments of the present disclosure may provide an all-solid-state battery fixing device that is configured to allow a heating and/or compression process of the all-solid-state battery to be performed precisely and an all-solid-state battery transfer system including the same.

The problems to be solved by the present disclosure are not limited to the problems mentioned above, and other problems and advantages of the present disclosure which are not mentioned may be understood by the following description, and may be more clearly understood by the embodiments of the present disclosure. In some embodiments, it may be confirmed that the problems to be solved by the present disclosure and advantages may be implemented by the means and combinations thereof described in the claims.

According to an aspect of an embodiment, an all-solid-state battery fixing device configured to be coupled to a transfer system for transferring an all-solid-state battery, includes a first transfer plate configured to be coupled to a first conveyor device of the transfer system, a second transfer plate configured to be coupled to a second conveyor device of the transfer system positioned apart from the first conveyor device, and to face the first transfer plate with the all-solid-state battery therebetween, a first fixing part configured to fix the first transfer plate to the first conveyor device, and to pass through the first transfer plate, and a second fixing part configured to fix the second transfer plate to the second conveyor device, to pass through the second transfer plate, and to be positioned at a position corresponding to the first fixing part.

In some embodiments, one side of the first transfer plate and one side of the second transfer plate may be positioned between the first fixing part and the second fixing part.

In some embodiments, a surface area of one side of the first transfer plate positioned between the first fixing part and the second fixing part and a surface area of one side of the second transfer plate positioned between the first fixing part and the second fixing part may be different.

In some embodiments, the first fixing part may include a first fixing element configured to be fastened to the first conveyor device, and a first through element configured to be connected to the first fixing element, and to pass through the first transfer plate.

In some embodiments, the first fixing element may be positioned at a position opposite the second transfer plate with respect to the first transfer plate.

In some embodiments, when viewed from one direction in which the first transfer plate and the second transfer plate are stacked, one side of the first fixing element overlaps the first transfer plate, and another side of the first fixing element which is positioned apart from the one side of the first fixing element may overlap the second transfer plate.

In some embodiments, the first through element simultaneously may pass through the first transfer plate and the second transfer plate.

In some embodiments, the second fixing part may include a second fixing element configured to be fastened to the second conveyor device, and a second through element configured to be connected to the second fixing element, and to pass through the second transfer plate.

In some embodiments, when viewed from one direction in which the first transfer plate and the second transfer plate are stacked, the first fixing element and the second through element may be arranged apart from each other.

In some embodiments, when viewed from the one direction, the first fixing element and the second fixing element may overlap each other.

Provided is an all-solid-state battery transfer system including an all-solid-state battery fixing device including a first transfer plate covering one surface of an all-solid-state battery and a second transfer plate covering another surface of the all-solid-state battery with the all-solid-state battery therebetween, a first conveyor device configured to transfer the first transfer plate, a second conveyor device configured to be positioned apart from the first conveyor device, and to transfer the second transfer plate, a heating unit configured to apply heat to the first transfer plate and the second transfer plate, and a compression unit configured to compress the first transfer plate and the second transfer plate.

In some embodiments, the all-solid-state battery fixing device further includes a first fixing part configured to fix the first transfer plate to the first conveyor device, and to pass through the first transfer plate, and a second fixing part configured to fix the second transfer plate to the second conveyor device, to pass through the second transfer plate, and to be positioned at a position corresponding to the first fixing part.

In some embodiments, the first fixing part may include a first fixing element configured to be fastened to the first conveyor device, and a first through element configured to be connected to the first fixing element, and to pass through the first transfer plate.

In some embodiments, the second fixing part may include a second fixing element configured to be fastened to the second conveyor device, and a second through element configured to be connected to the second fixing element, and to pass through the second transfer plate.

In some embodiments, when viewed from one direction in which the first transfer plate and the second transfer plate are stacked, the first fixing element and the second through element may be arranged apart from each other.

### BRIEF DESCRIPTION OF THE DRAWINGS

The following drawings of this description illustrate preferred embodiments of the present disclosure, and, together with disclosure of invention described below, serve to further understand a technical idea of the present disclosure, so that the present disclosure should not be interpreted as being limited to matters described in such drawings:

FIG. 1 is a perspective view of an all-solid-state battery transfer system according to an embodiment of the present disclosure;

FIG. 2 is a side view of the all-solid-state battery transfer system 1 illustrated in FIG. 1;

FIG. 3 is a perspective view of an all-solid-state battery fixing device according to an embodiment of the present disclosure;

FIG. 4 is an exploded perspective view of the all-solid-state battery fixing device illustrated in FIG. 3;

FIG. 5 is an enlarged view of part A of FIG. 1;

FIG. 6 is an enlarged view of part B of FIG. 1;

FIG. 7 is a view of the all-solid-state battery fixing device illustrated in FIG. 3 as viewed from above; and

FIG. 8 is a view of the all-solid-state battery fixing device illustrated in FIG. 3 as viewed from below.

### DETAILED DESCRIPTION

It is to be understood that the present disclosure is susceptible to various changes and may have numerous embodiments. Specific embodiments are illustrated in the drawings and described in the detailed description. The effects and features of the present disclosure, as well as a method of achieving them, will become apparent with reference to the embodiments described in detail below with the following drawings. However, the present disclosure is not limited to the embodiments disclosed herein and may be implemented in various forms.

In the following embodiments, terms such as “first,” “second,” etc. are used for the purpose of distinguishing one component from another and are not used to limit the components.

In the following embodiments, singular expressions are understood to include plural expressions unless the context clearly indicates otherwise.

In the following embodiments, terms such as “include,” or “have,” etc. are used to indicate the presence of the feature or the component described in the description, and do not exclude the possibility that one or more other features or components may be added.

In the following embodiments, when a portion of an unit, area, component, etc. is described as being “on” or “above” another portion, it includes not only the case where it is directly on or above another portion, but also the case where another unit, area, component, etc. is interposed therebetween.

In the following embodiments, terms such as “connect” or “couple” do not necessarily imply a direct and/or fixed connection or coupling of two elements, and do not exclude the interposition of another element between the two elements, unless the context clearly indicates otherwise.

In the drawings, the size of components may be exaggerated or reduced for convenience of description. For example, the size and/or thickness of each component illustrated in the drawings are arbitrarily shown for convenience of description, and therefore the present disclosure is not necessarily limited to what is illustrated.

Hereinafter, preferred embodiments of the present disclosure will be described in detail with reference to the following drawings. When describing with reference to the drawings, identical or corresponding components are denoted by the same drawing reference numerals, and any redundant description thereof will be omitted.

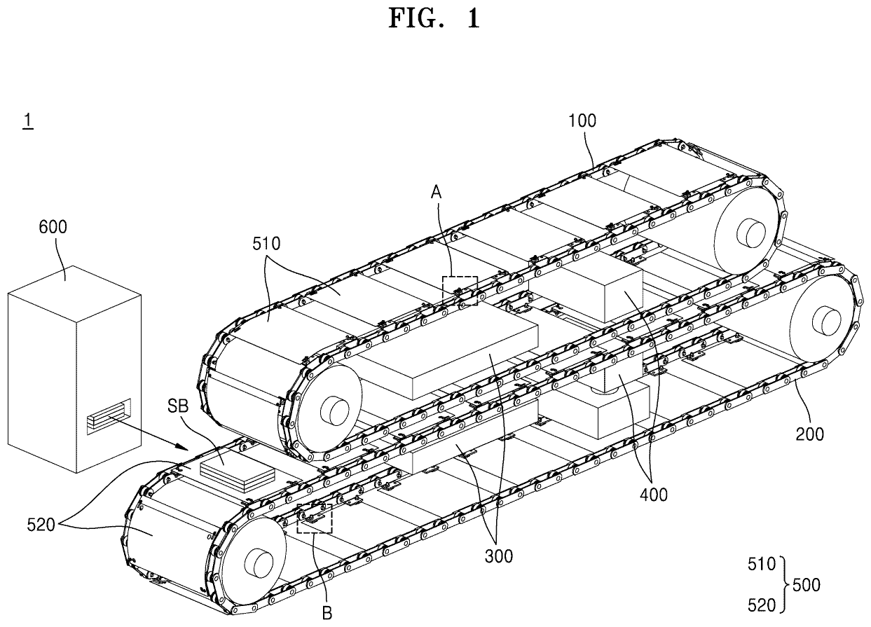

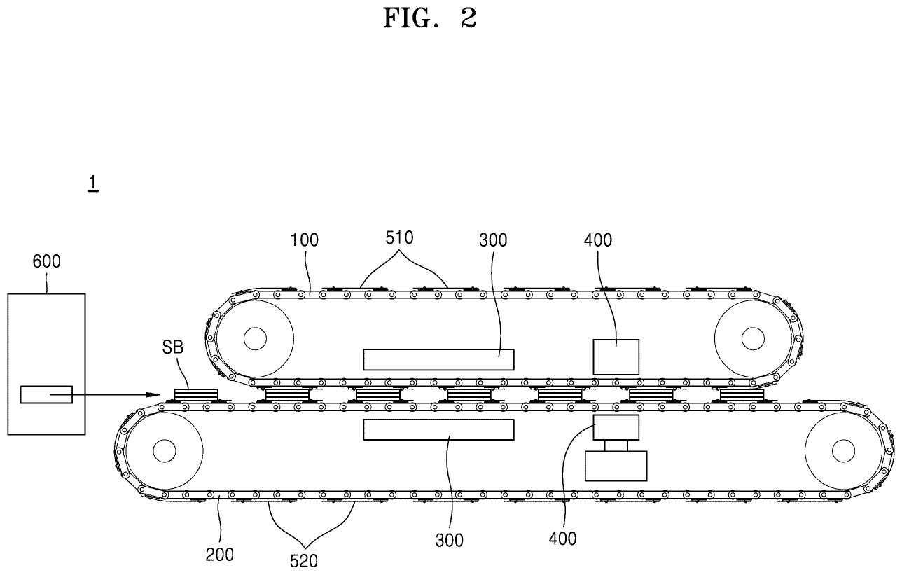

FIG. 1 is a perspective view of an all-solid-state battery transfer system 1 according to an embodiment of the present disclosure, and FIG. 2 is a side view of the all-solid-state battery transfer system 1 illustrated in FIG. 1.

Referring to FIGS. 1 and 2, an all-solid-state battery transfer system 1 according to an embodiment of the present disclosure heats an all-solid-state battery SB and applies pressure thereto while transferring the all-solid-state battery SB along a preset path, and may include a first conveyor device 100, a second conveyor device 200, a heating unit 300, a compression unit 400, an all-solid-state battery fixing device 500 and a supply unit 600.

The all-solid-state battery SB introduced into the all-solid-state battery transfer system 1 may move along the preset path, and while the all-solid-state battery SB moves along the preset path, a heating process and/or a compression process may be performed.

The all-solid-state battery SB may include a shape in which a positive electrode layer, a solid electrolyte layer and a negative electrode layer are sequentially stacked.

In some embodiments, the all-solid-state battery SB may be a mono-cell, but is not limited thereto, and the all-solid-state battery SB may include both a bi-cell and a stacked cell.

In this description, the mono-cell is a single cell composed of a single positive electrode layer, a single negative electrode layer and a single solid electrolyte layer, and the stacked cell may be interpreted as a cell in which a plurality of mono-cells are stacked and connected.

In some embodiments, the stacked cell may be a cell of a bi-polar structure.

The positive electrode layer may be a lithium oxide. In some embodiments, the positive electrode layer may include a layered compound such as a lithium cobalt oxide (LiCoO₂), a lithium nickel oxide (LiNiO₂), a compound substituted with one or more transition metals, a lithium manganese oxide such as LiMnO₃ and LiMn₂O₃, a lithium copper oxide, a vanadium oxide such as LiV₃O₈, LiFe₃O₄, V₂O₅ and Cu₂V₂O₇, an Ni-site type lithium nickel oxide, a lithium manganese composite oxide, or combinations thereof, but is not limited thereto, and the positive electrode layer may include various types of positive electrode materials within the technical scope of the positive electrode of the battery.

The negative electrode layer may include carbon such as non-graphitizable carbon, graphitic carbon (natural graphite, artificial graphite), a metal composite oxide such as LiₓFe₂O₃(0≤x≤1), LiₓWO₂(0≤x≤1), SnₓMe₁₋ₓMe′_{y}O_{z} (Me: Mn, Fe, Pb, Ge; Me: Al, B, P, Si, elements of group 1, 2 and 3 of the periodic table, halogen; 0<x≤1; 1≤y≤3; 1≤z≤8), a lithium metal, a lithium alloy, a silicon-based alloy, a tin-based alloy, a metal oxide such as SnO, SnO₂, PbO, PbO₂, Sb₂O₃, GeO, GeO₂, Bi₂O₃ and Bi₂O₄, a conductive polymer such as polyacetylene, a Li—Co—Ni-based material, a titanium oxide, a lithium titanium oxide, or combinations thereof, but is not limited thereto, and the negative electrode layer may include various types of negative electrode materials within the technical scope of the negative electrode of the battery.

The solid electrolyte layer may include at least one or more of a sulfide-based material such as LGPS (Li₁₀GeP₂S₁₂), LSPSCl (Li_{9.54}Si_{1.74}P_{1.44}S_{11.7}Cl_{0.3}), and Argyrodite, an oxide-based materials such as Perovskite (LLTO), Garnet (LLZO), NASICON, and LISICON, or a polymer-based material such as PEO, but is not limited thereto.

Referring to FIGS. 1 and 2, the first conveyor device 100 transfers a first transfer plate 510 described below, and a plurality of first transfer plates 510 may be connected to the first conveyor device 100.

In some embodiments, the first conveyor device 100 may be configured as a continuous circulation structure that circulates along a closed-loop path, and the plurality of first transfer plates 510 may be sequentially arranged along the closed-loop path.

The second conveyor device 200 transfers a second transfer plate 520 described below, and the plurality of second transfer plates 520 may be connected to the second conveyor device 200.

In some embodiments, the second conveyor device 200 may be configured as a continuous circulation structure that circulates along a closed-loop path, and the plurality of second transfer plates 520 may be sequentially arranged along the closed-loop path.

The first conveyor device 100 and the second conveyor device 200 may be arranged apart from each other, and the all-solid-state battery SB may pass between the first conveyor device 100 and the second conveyor device 200.

In some embodiments, the all-solid-state battery SB may be positioned between the first transfer plate 510 connected to the first conveyor device 100 and the second transfer plate 520 connected to the second conveyor device 200, and may be transferred along a circulation path of the first conveyor device 100 and/or the second conveyor device 200.

The first conveyor device 100 and the second conveyor device 200 may be arranged in parallel to each other in one direction.

The “one direction” may be interpreted as a direction in which the positive electrode layer, solid electrolyte layer, and negative electrode layer of the all-solid-state battery SB are stacked.

Referring to FIGS. 1 and 2, the heating unit 300 according to an embodiment of the present disclosure applies heat to the all-solid-state battery SB and may be positioned inside the first conveyor device 100 and/or inside the second conveyor device 200.

In some embodiments, the heating unit 300 may apply heat to the all-solid-state battery SB being transferred along the first conveyor device 100 and/or the second conveyor device 200, thereby implementing effects such as improvement of interfacial bonding of the all-solid-state battery SB, densification (sintering) of the solid electrolyte, chemical stabilization of the electrode/electrolyte interface, and formation and stabilization of a crystal structure.

A plurality of heating units 300 may be provided, and the plurality of heating units 300 may be respectively arranged inside the first conveyor device 100 and inside the second conveyor device 200.

In some embodiments, the heating unit 300 positioned inside the first conveyor device 100 may apply heat to the first transfer plate 510 in contact with one surface of the all-solid-state battery SB, and the heating unit 300 positioned inside the second conveyor device 200 may apply heat to the second transfer plate 520 in contact with another surface of the all-solid-state battery SB.

The first transfer plate 510 and the second transfer plate 520 may be in surface contact with an outer circumferential surface of the all-solid-state battery SB, and the heating unit 300 indirectly applies heat to the all-solid-state battery SB through the first transfer plate 510 and the second transfer plate 520 which are in surface contact with the all-solid-state battery SB over a wide area, rather than directly applying heat to the all-solid-state battery SB, thereby providing an effect in which a heat emitted from the heating unit 300 may be uniformly applied to the all-solid-state battery SB.

Referring to FIGS. 1 and 2, the compression unit 400 according to an embodiment of the present disclosure compresses the all-solid-state battery SB and may be positioned inside the first conveyor device 100 and/or inside the second conveyor device 200.

In some embodiments, the compression unit 400 may apply pressure to the all-solid-state battery SB being transferred along the first conveyor device 100 and/or the second conveyor device 200, thereby implementing effects such as enhancing interfacial adhesion of the all-solid-state battery SB, densification (sintering) of the solid electrolyte, and ensuring mechanical stability.

A plurality of compression units 400 may be provided, and the plurality of compression units 400 may be respectively arranged inside the first conveyor device 100 and inside the second conveyor device 200.

In some embodiments, the compression unit 400 positioned inside the first conveyor device 100 may apply pressure to the first transfer plate 510 in contact with one surface of the all-solid-state battery SB, and the compression unit 400 positioned inside the second conveyor device 200 may apply pressure to the second transfer plate 520 in contact with another surface of the all-solid-state battery SB.

That is, the compression unit 400 applies pressure to the first transfer plate 510 and the second transfer plate 520 which are in surface contact with the all-solid-state battery SB over a wide area, rather than directly contacting the all-solid-state battery SB, thereby compressing the all-solid-state battery SB so that an uniform compressing force may be applied to the all-solid-state battery SB, while simultaneously and effectively protecting the durability of the all-solid-state battery SB.

In some embodiments, the compression unit 400 may include a heater. As a result, heat may be applied to the all-solid-state battery SB while the compression unit 400 applies pressure to the all-solid-state battery SB, thereby allowing compressed fixation of the all-solid-state battery SB to be effectively achieved.

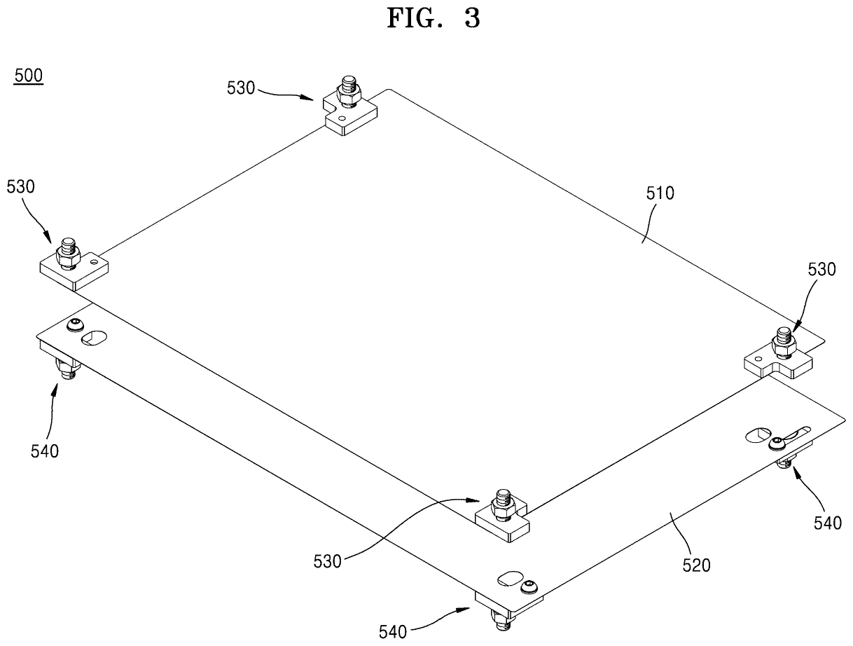

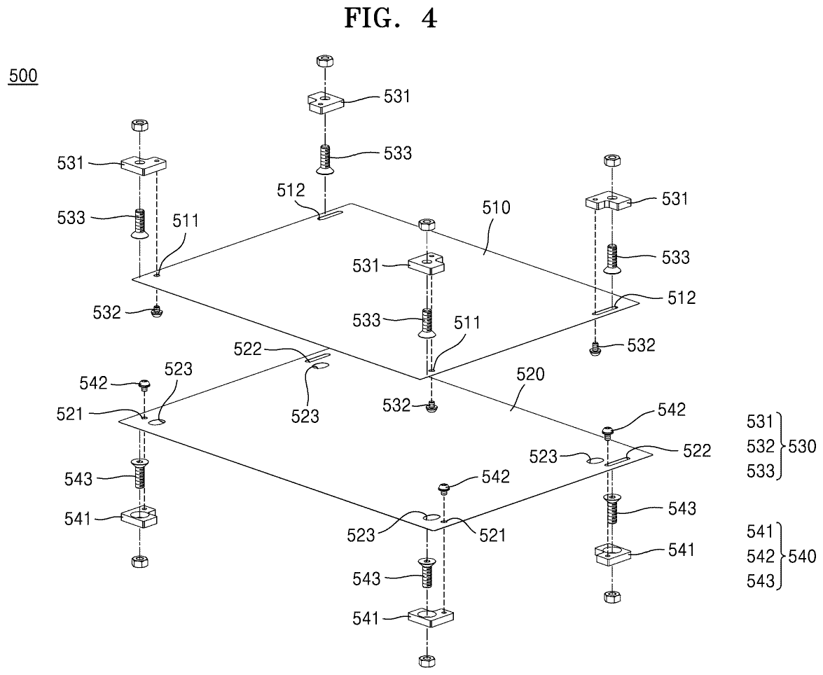

FIG. 3 is a perspective view of an all-solid-state battery fixing device 500 according to an embodiment of the present disclosure, and FIG. 4 is an exploded perspective view of the all-solid-state battery fixing device 500 illustrated in FIG. 3.

Referring to FIGS. 3 and 4, the all-solid-state battery fixing device 500 according to an embodiment of the present disclosure covers the outer circumferential surface of the all-solid-state battery SB, and may include the first transfer plate 510, the second transfer plate 520, a first fixing part 530 and a second fixing part 540.

The all-solid-state battery fixing device 500 may be fastened to the all-solid-state battery transfer system 1. In some embodiments, the all-solid-state battery fixing device 500 may be detachably fastened to the all-solid-state battery transfer system 1.

As a result, when a part of the all-solid-state battery fixing device 500 is damaged due to the driving of the heating unit 300 or the compression unit 400, replacement of only a damaged all-solid-state battery fixing device 500 in the first conveyor device 100 and the second conveyor device 200 is facilitated.

In some embodiments, the plurality of first transfer plates 510 may be detachably fastened to the first conveyor device 100, and the plurality of second transfer plates 520 may be detachably fastened to the second conveyor device 200. When one of the plurality of first transfer plates 510 and the second transfer plates 520 is damaged, replacement of only a damaged first transfer plate 510 or second transfer plate 520 by separating it from the first conveyor device 100 or the second conveyor device 200 is facilitated.

Referring to FIGS. 1, 3 and 4, the first transfer plate 510 is connected to the first conveyor device 100 and may move along the circulation path of the first conveyor device 100.

The first transfer plate 510 may be in surface contact with one surface of the all-solid-state battery SB to cover the one surface.

In some embodiments, the first transfer plate 510 may cover one surface of the all-solid-state battery SB that is seated on the second transfer plate 520.

The first transfer plate 510 may have a shape of a flat plate, and a thickness of the first transfer plate 510 may be relatively thinner than a thickness of the all-solid-state battery SB.

In some embodiments, the thickness of the first transfer plate 510 may be 1 mm or less, 0.5 mm or less, or 0.2 mm or less.

As a result, the first transfer plate 510 has a relatively thin thickness compared to the all-solid-state battery SB, so that the first transfer plate 510 may effectively protect the outer circumferential surface of the all-solid-state battery SB, while simultaneously and effectively transferring heat or pressure from the outside to the outer circumferential surface of the all-solid-state battery SB.

The second transfer plate 520 is connected to the second conveyor device 200 and may move along the circulation path of the second conveyor device 200.

The second transfer plate 520 may be in surface contact with another surface of the all-solid-state battery SB to cover the other surface. In some embodiments, the second transfer plate 520 may be in surface contact with another surface of the all-solid-state battery SB opposite to one surface in surface contact with the first transfer plate 510 to cover the other surface.

Referring again to FIGS. 1 and 2, the all-solid-state battery SB supplied from the supply unit 600 may be seated on the second transfer plate 520.

The all-solid-state battery SB seated on the second transfer plate 520 may be transferred along the circulation path of the second conveyor device 200, and the all-solid-state battery SB transferred along the second conveyor device 200 may receive heat and pressure from the heating unit 300 and the compression unit 400.

The second transfer plate 520 may have a shape of a flat plate, and a thickness of the second transfer plate 520 may be relatively thinner than a thickness of the all-solid-state battery SB.

In some embodiments, the first transfer plate 510 and the second transfer plate 520 may have the same thickness.

In some embodiments, the thickness of the second transfer plate 520 may be 1 mm or less, 0.5 mm or less, or 0.2 mm or less.

As a result, the second transfer plate 520 has a relatively thin thickness compared to the all-solid-state battery SB, so that the second transfer plate 520 may effectively protect the outer circumferential surface of the all-solid-state battery SB, while simultaneously and effectively transferring heat or pressure from the outside to the outer circumferential surface of the all-solid-state battery SB.

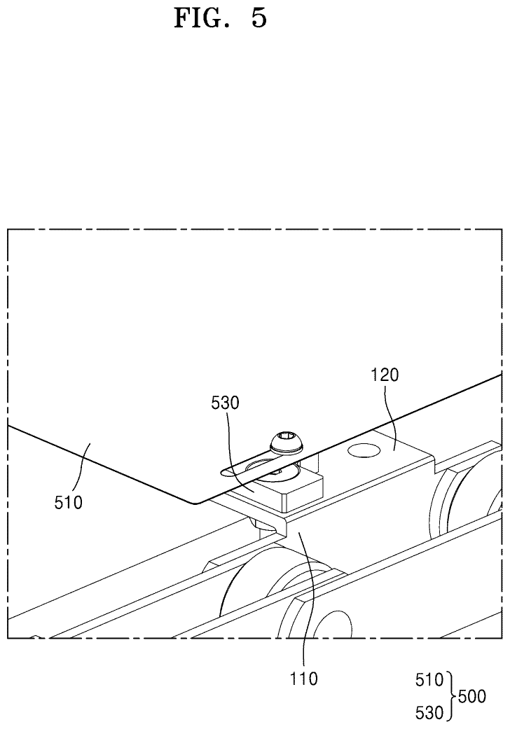

FIG. 5 is an enlarged view of part A of FIG. 1.

Referring to FIGS. 3 to 5, the first fixing part 530 according to an embodiment of the present disclosure fixes the first transfer plate 510 to the first conveyor device 100, and may include a first fixing element 531, a first through element 532, and a first support element 533.

Referring to FIGS. 4 and 5, the first fixing element 531 is fastened to the first conveyor device 100, and may be connected to the first conveyor device 100 and the first transfer plate 510, respectively.

The first fixing element 531 may be positioned at a position opposite the second transfer plate 520 with respect to the first transfer plate 510.

In some embodiments, the first transfer plate 510 may be positioned between the first fixing element 531 and the second transfer plate 520, and the first fixing element 531 may be connected to the first transfer plate 510, but may be positioned apart from the second transfer plate 520.

When viewed from one direction in which the first transfer plate 510 and the second transfer plate 520 are stacked (hereinafter, referred to as a ‘stacking direction’), the first fixing element 531 may be positioned apart from the second through element 542 described below.

In some embodiments, when viewed from the stacking direction, the first fixing element 531 may overlap the first transfer plate 510, the second transfer plate 520 and a second fixing element 541, but may be positioned apart from the second through element 542.

As a result, even if the first transfer plate 510 and the second transfer plate 520 are compressed in a direction that brings them closer to each other, mechanical interference between the first fixing element 531 and the second through element 542 may be avoided.

A plurality of first fixing elements 531 may be provided, and in some embodiments, the first fixing elements 531 may be arranged at the front side and rear side in a movement direction of the first transfer plate 510, respectively.

The first fixing element 531 may be positioned in and fixed to the first conveyor device 100 through the first support element 533.

Referring to FIG. 5, the first conveyor device 100 may include a first chain body 110 that moves along an infinite track, and a first connection part 120 that protrudes from one side of the first chain body 110 toward the all-solid-state battery fixing device 500.

The first fixing element 531 may be positioned in and fixed to the first connection part through the first support element 533. In some embodiments, the first support element 533 may simultaneously pass through the first fixing element 531 and the first connection part, thereby positioning the first fixing element 531 in the first connection part and fixing the first fixing element 531 to the first connection part.

As a result, the first transfer plate 510 connected to the first fixing element 531 may be fixed to the first conveyor device 100.

In some embodiments, the first support element 533 may include various devices capable of fixing the first fixing element 531 to the first conveyor device 100, and in some embodiments, the first support element 533 may include a bolt-nut combination, a clamp, a bracket, a rivet, a welded structure, an adhesive, or a quick release (fastener) device.

The first through element 532 connects the first transfer plate 510 to the first fixing element 531, and the first through element 532 is connected to the first fixing element 531 and may pass through the first transfer plate 510.

In some embodiments, a first front hole portion 511 is formed on a front side of the first transfer plate 510, a first rear slit 512 is formed on a rear side of the first transfer plate 510, and the first fixing element 531 may be positioned to pass through the first front hole portion 511 and the first rear slit 512.

The “front side” is interpreted as the front side in the movement direction of the first transfer plate 510, and the “rear side” is defined as the rear area behind the front side with respect to the movement direction of the first transfer plate 510.

The first front hole portion 511 may have a shape of a cylindrical hole to correspond to the shape of the outer circumferential surface of the first through element 532.

As a result, the first through element 532 is inserted into the first front hole portion 511, so that the first transfer plate 510 and the first fixing element 531 may be arranged and fixed relative to each other so that the first transfer plate 510 may move by the movement of the first conveyor device 100 connected to the first fixing element 531.

The first rear slit 512 may have a shape of a slit that extends long along the movement direction of the first transfer plate 510.

In some embodiments, a length of the first rear slit 512 extending along the movement direction of the first transfer plate 510 may be relatively longer than a length of the first front hole portion 511 extending along the movement direction of the first transfer plate 510.

The first through element 532 positioned through the first rear slit 512 may move along the first rear slit 512 so that the first transfer plate 510 may move relative to the first fixing element 531 corresponding to the rear slit.

As a result, even if the first transfer plate 510 is bent while the first transfer plate 510 moves in a curved manner along the first conveyor device 100, the rear side of the first transfer plate 510 may be connected to the first fixing element 531 while flexibly moving relative to the first fixing element 531.

Through this, even if the first transfer plate 510 moves along a curved path, the first fixing part 530 may flexibly connect the first transfer plate 510 to the first conveyor device 100.

The first through element 532 may simultaneously pass through the first transfer plate 510 and the second transfer plate 520.

When viewed from the stacking direction, the first through element 532 and the second transfer plate 520 may be arranged apart from each other.

In some embodiments, a through hole portion 523 may be formed in an area of the second transfer plate 520 corresponding to a longitudinal central axis of the first through element 532, and an end portion of the first through element 532 that sequentially passes through the first fixing element 531 and the first transfer plate 510 may be positioned inside the through hole portion 523 without contacting the second transfer plate 520.

As a result, even if the end portion of the first through element 532 protrudes from the first transfer plate 510 toward the second transfer plate 520, interference between the first through element 532 and the second transfer plate 520 may be prevented by forming the through hole portion 523 in the second transfer plate 520.

As a result, the first through element 532 may firmly fix the first transfer plate 510 to the first fixing element 531 without interference with the second transfer plate 520.

In some embodiments, the first through element 532 may include various devices capable of fixing the first transfer plate 510 to the first fixing element 531, and in some embodiments, the first through element 532 may include a bolt-nut combination, a clamp, a bracket, a rivet, a welded structure, an adhesive, or a quick release (fastener) device.

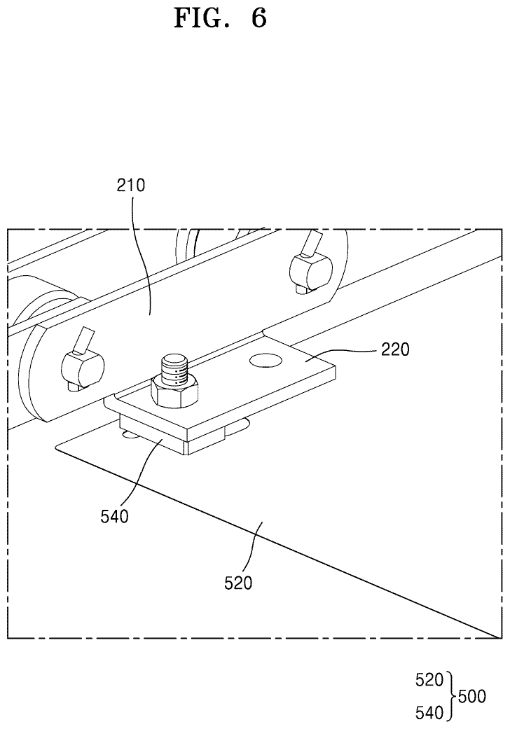

FIG. 6 is an enlarged view of part B of FIG. 1.

Referring to FIGS. 3, 4 and 6, the second fixing part 540 according to an embodiment of the present disclosure fixes the second transfer plate 520 to the second conveyor device 200, and may include the second fixing element 541, the second through element 542 and a second support element 543.

Referring to FIGS. 4 and 6, the second fixing element 541 is fastened to the second conveyor device 200, and may be connected to the second conveyor device 200 and the second transfer plate 520, respectively.

The second fixing element 541 may be positioned at a position opposite the first transfer plate 510 with respect to the second transfer plate 520.

In some embodiments, the second transfer plate 520 may be positioned between the second fixing element 541 and the first transfer plate 510, and the second fixing element 541 may be connected to the second transfer plate 520, but may be positioned apart from the first transfer plate 510.

When viewed from the stacking direction, the second fixing element 541 may be positioned apart from the first through element 532 described below.

In some embodiments, when viewed from the stacking direction, the second fixing element 541 may overlap the first transfer plate 510, the second transfer plate 520 and a first fixing element 531, but may be positioned apart from the first through element 532.

As a result, even if the first transfer plate 510 and the second transfer plate 520 are compressed in a direction that brings them closer to each other, mechanical interference between the second fixing element 541 and the first through element 532 may be avoided.

A plurality of second fixing elements 541 may be provided, and in some embodiments, the second fixing elements 541 may be arranged at the front side and rear side in a movement direction of the second transfer plate 520, respectively.

The second fixing element 541 may be positioned in and fixed to the second conveyor device 200 through the second support element 543.

Referring to FIG. 6, the second conveyor device 200 may include a second chain body 210 that moves along an infinite track, and a second connection part 220 that protrudes from the second chain body 210 toward one side of the second chain body 210.

The second fixing element 541 may be positioned in and fixed to the second connection part through the second support element 543. In some embodiments, the second support element 543 may simultaneously pass through the second fixing element 541 and the second connection part, thereby positioning the second fixing element 541 in the second connection part and fixing the second fixing element 541 to the second connection part.

As a result, the second transfer plate 520 connected to the second fixing element 541 may be fixed to the second conveyor device 200.

In some embodiments, the second support element 543 may include various devices capable of fixing the second fixing element 541 to the second conveyor device 200, and in some embodiments, the second support element 543 may include a bolt-nut combination, a clamp, a bracket, a rivet, a welded structure, an adhesive, or a quick release device.

The second through element 542 connects the second transfer plate 520 to the second fixing element 541, and the second through element 542 is connected to the second fixing element 541 and may pass through the second transfer plate 520.

In some embodiments, a second front hole portion 521 is formed on a front side of the second transfer plate 520, a second rear slit 522 is formed on a rear side of the second transfer plate 520, and the second fixing element 541 may be positioned to pass through the second front hole portion 521 and the second rear slit.

The “front side” is interpreted as the front side in the movement direction of the second transfer plate 520, and the “rear side” is defined as the rear area behind the front side with respect to the movement direction of the second transfer plate 520.

The second front hole portion 521 may have a shape of a cylindrical hole to correspond to the shape of the outer circumferential surface of the second through element 542.

As a result, the second through element 542 is inserted into the second front hole portion 521, so that the second transfer plate 520 and the second fixing element 541 may be arranged and fixed relative to each other so that the second transfer plate 520 may move by the movement of the second conveyor device 200 connected to the second fixing element 541.

The second rear slit 522 may have a shape of a slit that extends long along the movement direction of the second transfer plate 520.

In some embodiments, a length of the second rear slit 522 extending along the movement direction of the second transfer plate 520 may be relatively longer than a length of the second front hole portion 521 extending along the movement direction of the second transfer plate 520.

The second through element 542 positioned through the second rear slit 522 may move along the second rear slit 522 so that the second transfer plate 520 may move relative to the second fixing element 541 corresponding to the rear slit.

As a result, even if the second transfer plate 520 is bent while the second transfer plate 520 moves in a curved manner along the second conveyor device 200, the rear side of the second transfer plate 520 may be connected to the second fixing element 541 while flexibly moving relative to the second fixing element 541.

Through this, even if the second transfer plate 520 moves along a curved path, the second fixing part 540 may flexibly connect the second transfer plate 520 to the second conveyor device 200.

When viewed from the stacking direction, the second through element 542 and the first transfer plate 510 may be arranged apart from each other.

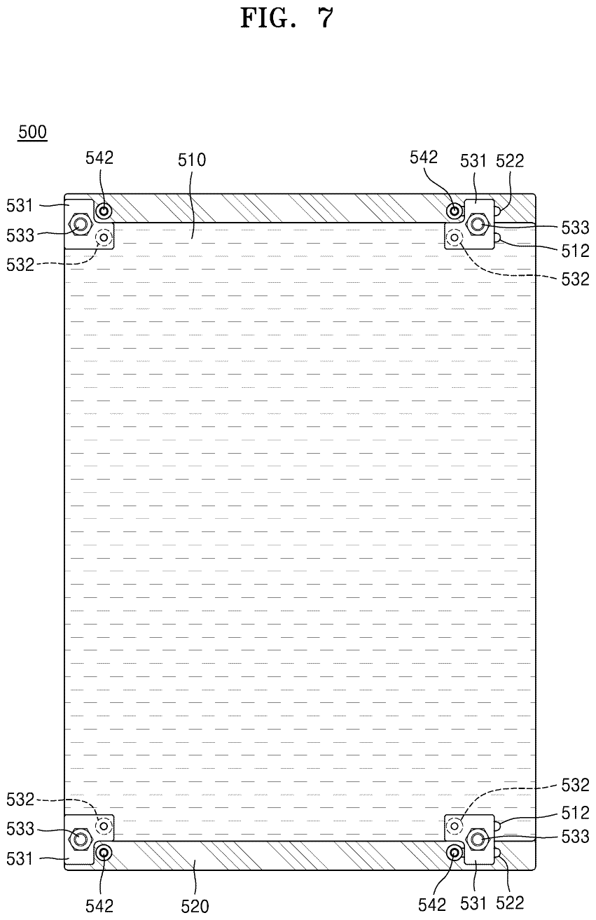

In some embodiments, when viewed from the stacking direction, the longitudinal central axis of the first through element 532 may be positioned on an outer side of the first transfer plate 510. (see FIG. 7)

As a result, even if an end portion of the second through element 542 protrudes from the second transfer plate 520 toward the first transfer plate 510, interference between the second through element 542 and the first transfer plate 510 may be prevented by positioning the first transfer plate 510 at a position spaced apart from the second through element 542.

As a result, the second through element 542 may firmly fix the second transfer plate 520 to the second fixing element 541 without interference with the first transfer plate 510.

That is, interference with the second transfer plate 520 may be avoided as the first through element 532 passes through the first transfer plate 510 and the through hole portion 523 of the second transfer plate 520, and interference with the first transfer plate 510 may be avoided as the second through element 542 passes through the second transfer plate 520 while being positioned apart from the first transfer plate 510.

In some embodiments, the second through element 542 may include various devices capable of fixing the second transfer plate 520 to the second fixing element 541, and in some embodiments, the second through element 542 may include a bolt-nut combination, a clamp, a bracket, a rivet, a welded structure, an adhesive, or a quick release (fastener) device.

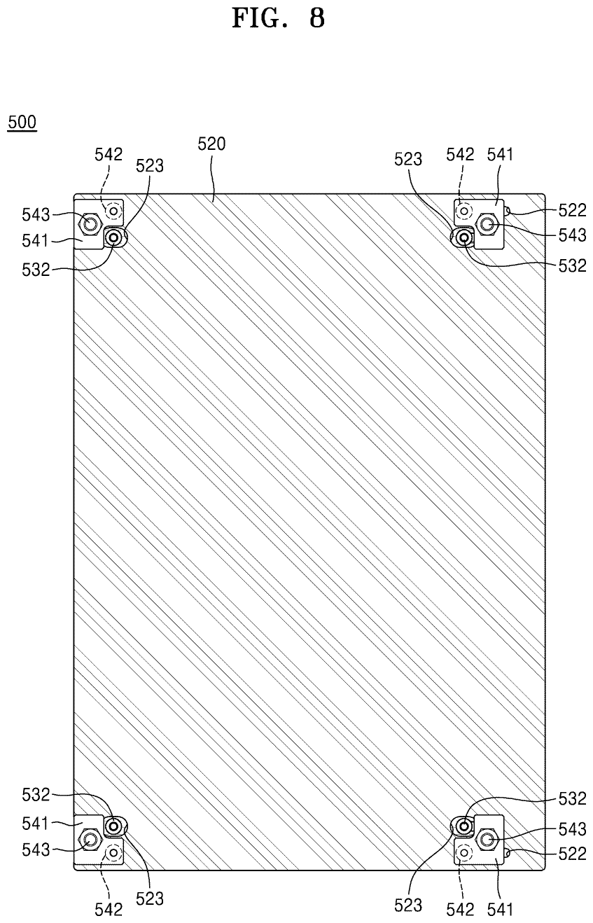

FIG. 7 is a view of the all-solid-state battery fixing device 500 illustrated in FIG. 3 as viewed from an upper side, and FIG. 8 is a view of the all-solid-state battery fixing device 500 illustrated in FIG. 3 as viewed from a lower side.

FIGS. 7 and 8 are views viewed from a direction in which the first transfer plate 510 and the second transfer plate 520 are stacked. In some embodiments, FIG. 7 is a view of the all-solid-state battery fixing device 500 viewed from an upper side in the stacking direction, and FIG. 8 is a view of the all-solid-state battery fixing device 500 viewed from a lower side in the stacking direction.

Referring to FIGS. 4, 7 and 8, one side of the first transfer plate 510 and one side of the second transfer plate 520 may be positioned between the first fixing part 530 and the second fixing part 540.

A surface area of one side of the first transfer plate 510 positioned between the first fixing part 530 and the second fixing part 540 and a surface area of one side of the second transfer plate 520 positioned between the first fixing part 530 and the second fixing part 540 may be different.

In some embodiments, the surface area of one side of the first transfer plate 510 positioned between the first fixing part 530 and the second fixing part 540 may be smaller than the surface area of one side of the second transfer plate 520 positioned between the first fixing part 530 and the second fixing part 540.

Referring to FIG. 7, when viewed from the stacking direction, the first fixing element 531 may be positioned apart from the second through element 542.

As a result, even if the first transfer plate 510 and the second transfer plate 520 are in close contact, damage due to the contact between the first fixing element 531 and the second through element 542 may be prevented.

Referring to FIG. 7, when viewed from the stacking direction, the first transfer plate 510 may be positioned apart from the second through element 542.

As a result, even if the first transfer plate 510 and the second transfer plate 520 are in close contact, damage of the first transfer plate 510 due to a contact with the second through element 542 may be prevented.

Referring to FIG. 8, when viewed from the stacking direction, the second fixing element 541 may be positioned apart from the first through element 532.

As a result, even if the first transfer plate 510 and the second transfer plate 520 are in close contact, damage due to the contact between the second fixing element 541 and the first through element 532 may be prevented.

Referring to FIG. 8, when viewed from the stacking direction, the second transfer plate 520 may be positioned apart from the first through element 532.

In some embodiments, when viewed from the stacking direction, the first through element 532 may overlap the through hole portion 523 formed in the second transfer plate 520.

As a result, even if the first transfer plate 510 and the second transfer plate 520 are in close contact, damage of the second transfer plate 520 due to a contact with the first through element 532 may be prevented.

An all-solid-state battery fixing device 500 and an all-solid-state battery transfer system 1 including the same according to embodiments of the present disclosure include a first transfer plate 510 and a second transfer plate 520 that are detachable from a conveyor device and configured to make surface contact with an outer circumferential surface of the all-solid-state battery SB, thereby facilitating replacement of the all-solid-state battery fixing device 500 and enabling a heating and/or compression process of the all-solid-state battery SB to be performed uniformly.

An all-solid-state battery fixing device and an all-solid-state battery transfer system including the same according to embodiments of the present disclosure include a first transfer plate and a second transfer plate that are detachable from a conveyor device and configured to make surface contact with an outer circumferential surface of the all-solid-state battery, thereby facilitating replacement of the all-solid-state battery fixing device and enabling a heating and/or compression process of the all-solid-state battery to be performed uniformly.

However, the effects which may be obtained through the present disclosure are not limited to the above described effects, and other technical effects which are not mentioned may be clearly understood by a person skilled in the art from the specification described below.

Each of the embodiments described above may be implemented independently, but it is to be understood that the structure of each embodiment may be applied in combination to other embodiments.

Although the present disclosure has been described with reference to the embodiments illustrated in the drawings, these are merely exemplary, and it will be understood by a person skilled in the art that various changes and other equivalent embodiments are possible from the above embodiments. Therefore, the true technical scope of the present disclosure should be defined by the following claims.

The specific implementations described in the embodiments are merely examples, and the scope of the embodiments is not limited thereby. Additionally, unless specifically described as “essential” or “significant,” the components described may not be necessary for the application of the present disclosure.

In the description of the embodiments (especially in the claims), terms such as “the”and similar terms may be in opposite singular and plural.

Additionally, when a range is described in an embodiment, individual values within the range are included, (unless otherwise stated), and it is the same as describing each individual value constituting the range in the detailed description.

Finally, unless there is an explicit description or contradiction of the order of steps that constitute the method according to the embodiment, the steps may be performed in any suitable order. The embodiments are not necessarily limited to the order in which the steps are described.

The use of all examples or exemplary terms in the embodiments is merely for detailed explanation, and unless limited by the claims, the scope of the embodiments is not limited by these examples or exemplary terms.

Additionally, a person skilled in the art will recognize that various modifications, combinations, and changes may be made within the scope of the claims or their equivalents, depending on design conditions and factors.

What is claimed is:

1. An all-solid-state battery fixing device configured to be coupled to a transfer system for transferring an all-solid-state battery, the all-solid-state battery fixing device comprising:
a first transfer plate configured to be coupled to a first conveyor device of the transfer system;
a second transfer plate configured to be coupled to a second conveyor device of the transfer system positioned apart from the first conveyor device, and to face the first transfer plate with the all-solid-state battery therebetween;
a first fixing part configured to fix the first transfer plate to the first conveyor device, and to pass through the first transfer plate; and
a second fixing part configured to fix the second transfer plate to the second conveyor device, to pass through the second transfer plate, and to be positioned at a position corresponding to the first fixing part.

2. The all-solid-state battery fixing device of claim 1, wherein
one side of the first transfer plate and one side of the second transfer plate are positioned between the first fixing part and the second fixing part.

3. The all-solid-state battery fixing device of claim 2, wherein
a surface area of one side of the first transfer plate positioned between the first fixing part and the second fixing part is different from a surface area of one side of the second transfer plate positioned between the first fixing part and the second fixing part.

4. The all-solid-state battery fixing device of claim 1, wherein
the first fixing part comprises:
a first fixing element configured to be fastened to the first conveyor device; and
a first through element configured to be connected to the first fixing element, and to pass through the first transfer plate.

5. The all-solid-state battery fixing device of claim 4, wherein
the first fixing element is configured to be positioned at a position opposite the second transfer plate with respect to the first transfer plate.

6. The all-solid-state battery fixing device of claim 4, wherein
when viewed from one direction in which the first transfer plate and the second transfer plate are stacked,
one side of the first fixing element overlaps the first transfer plate, and another side of the first fixing element, which is positioned apart from the one side of the first fixing element, overlaps the second transfer plate.

7. The all-solid-state battery fixing device of claim 5, wherein
the first through element simultaneously passes through the first transfer plate and the second transfer plate.

8. The all-solid-state battery fixing device of claim 4, wherein
the second fixing part comprises:
a second fixing element configured to be fastened to the second conveyor device; and
a second through element configured to be connected to the second fixing element, and to pass through the second transfer plate.

9. The all-solid-state battery fixing device of claim 8, wherein
when viewed from one direction in which the first transfer plate and the second transfer plate are stacked,
the first fixing element and the second through element are arranged apart from each other.

10. The all-solid-state battery fixing device of claim 9, wherein
when viewed from the one direction,
the first fixing element and the second fixing element overlap each other.

11. An all-solid-state battery transfer system comprising:
an all-solid-state battery fixing device including a first transfer plate covering one surface of an all-solid-state battery and a second transfer plate covering another surface of the all-solid-state battery with the all-solid-state battery therebetween;
a first conveyor device configured to transfer the first transfer plate;
a second conveyor device configured to be positioned apart from the first conveyor device, and to transfer the second transfer plate;
a heating unit configured to apply heat to the first transfer plate and the second transfer plate; and
a compression unit configured to compress the first transfer plate and the second transfer plate.

12. The all-solid-state battery transfer system of claim 11, wherein
the all-solid-state battery fixing device further comprises:
a first fixing part configured to fix the first transfer plate to the first conveyor device, and to pass through the first transfer plate; and
a second fixing part configured to fix the second transfer plate to the second conveyor device, to pass through the second transfer plate, and to be positioned at a position corresponding to the first fixing part.

13. The all-solid-state battery transfer system of claim 12, wherein
the first fixing part comprises:
a first fixing element configured to be fastened to the first conveyor device; and
a first through element configured to be connected to the first fixing element, and to pass through the first transfer plate.

14. The all-solid-state battery transfer system of claim 13, wherein
the second fixing part comprises:
a second fixing element configured to be fastened to the second conveyor device; and
a second through element configured to be connected to the second fixing element, and to pass through the second transfer plate.

15. The all-solid-state battery transfer system of claim 14, wherein
when viewed from one direction in which the first transfer plate and the second transfer plate are stacked,
the first fixing element and the second through element are arranged apart from each other.
